(19) United States
(12) Patent Application Publication
(10) Pub. No.: US 2013/0155003 A1
(43) Pub. Date: Jun. 20, 2013

(54) TOUCH SENSING APPARATUS AND METHOD THEREOF

(71) Applicants: Yong Il KWON, Suwon (KR); Tah Joon PARK, Suwon (KR); Sang Ho LEE, Suwon (KR)

(72) Inventors: Yong Il KWON, Suwon (KR); Tah Joon PARK, Suwon (KR); Sang Ho LEE, Suwon (KR)

(73) Assignee: SAMSUNG ELECTRO-MECHANICS CO., LTD., Suwon (KR)

(21) Appl. No.: 13/401,362

(22) Filed: Feb. 21, 2012

(30) Foreign Application Priority Data
Dec. 14, 2011 (KR) 10-2011-0134253

(51) Int. Cl. G06F 3/044

(52) U.S. Cl. 345/174

(57) ABSTRACT

There are provided a touch sensing apparatus and a touch sensing method. The touch sensing apparatus includes: a plurality of first electrodes extending along a first axis; a plurality of second electrodes extending along a second axis intersecting the first axis and forming a plurality of intersection points by intersecting the plurality of first electrodes; and a controller integrated circuit determining a touch by detecting changes in capacitance generated in the plurality of intersection points, wherein the controller integrated circuit sets parameters for detecting the changes in capacitance differently according to positions of the plurality of intersection points.

### CROSS-REFERENCE TO RELATED APPLICATIONS

This application claims the priority of Korean Patent Application No. 10-2011-0134253 filed on Dec. 14, 2011, in the Korean Intellectual Property Office, the disclosure of which is incorporated herein by reference.

### BACKGROUND OF THE INVENTION

1. Field of the Invention

The present invention relates to a touch sensing apparatus and a method thereof that can accurately determine a touch, regardless of electric noise in a signal and a position of the touch inputted into the touch sensing apparatus.

2. Description of the Related Art

Touch sensing apparatuses such as a touch screen, a touch pad, and the like, as user interface apparatuses attached to a display apparatus to provide an intuitive input method to a user, have been widely applied to a variety of electronic apparatuses such as a cellular phone, a personal digital assistant (PDA), a navigation device and the like, in recent years. In particular, recently, with the increase in demand for smart phones, the rate at which a touch screen has been adopted as a touch sensing apparatus capable of providing various input methods in a limited form factor has increased on a daily basis.

Touch screens adopted in portable electronic apparatuses may be largely classified into resistive type and capacitive type touch screens, according to a touch sensing method. Since the capacitive type touch screen is advantageous in that a life-span thereof may be relatively extended, and various input methods and gestures can be easily implemented therein, the adoption rate of the capacitive type touch screen has steadily increased. In particular, it is easier to implement a multi-touch interface in the capacitive type touch screen than in the resistive type touch screen, and as a result, the capacitive type touch screen is widely applied to an electronic apparatus such as a smart phone, or the like.

Touch screens are generally attached to a front surface of the display apparatus while touch sensing apparatuses other than touch screens are also generally provided within the electronic apparatus. Accordingly, touch sensing accuracy may be deteriorated due to noise generated by various electronic components, e.g., a wireless communication unit, the display apparatus, a power device, and the like, provided together with the touch screen in the electronic apparatus. An additional shielding layer may be provided between the display apparatus and the touch screen in order to solve the problem, but in this case, overall light transmittance may be deteriorated, and device thickness may be increased.

Further, a panel unit of the touch screen includes a plurality of electrodes in which changes in capacitance are generated, according to touches, and the plurality of electrodes have unique resistance values. Therefore, since the resistance values of the electrodes in which the changes in capacitance are generated by touches are different from each other, an error in determining a touch may occur in the case that the touch is determined without consideration of differences in resistance values.

According to the related art, Korean Patent Laid-Open Publication No. 10-2011-0009895 discloses a configuration of connecting two sensing channels to a single touch screen sensing electrode and considering a temporal difference reflected in voltage charging and discharging characteristics by voltage variations, according to the time thereof in each channel, while U.S. Patent Application Publication No. 2011/0175847 discloses a configuration of controlling a frequency of a driving signal applied to the touch screen.

### SUMMARY OF THE INVENTION

An aspect of the present invention provides a touch sensing apparatus and a method for sensing a touch in which parameters required to detect changes in capacitance are applied differently, according to positions in which changes in capacitance on a 2D plane of a panel unit are detected, in order to generate an analog signal from the changes in capacitance. Accordingly, a touch can be accurately determined by considering an influence of electric noise generated from other electronic components provided adjacent to a touch sensing apparatus, e.g., an RF module, a display device, an audio/video driving circuit unit, and an antenna unit, and a difference in electric signal transmission characteristics, according to positions in which changes in capacitance are detected.

According to an aspect of the present invention, there is provided a touch sensing apparatus including: a plurality of first electrodes extending along a first axis; a plurality of second electrodes extending along a second axis intersecting the first axis and forming a plurality of intersection points by intersecting the plurality of first electrodes; and a controller integrated circuit determining a touch by detecting changes in capacitance generated in the plurality of intersection points, wherein the controller integrated circuit sets parameters for detecting the changes in capacitance differently according to positions of the plurality of intersection points.

The controller integrated circuit may include a sensing circuit unit including an integral circuit detecting the changes in capacitance; a signal converting unit generating a digital signal from the changes in capacitance detected by the sensing circuit unit; and a calculating unit determining the touch from the digital signal.

The sensing circuit unit may set time intervals differently for the integral circuit to detect the changes in capacitance according to the positions of the plurality of intersection points.

The sensing circuit unit may increase the time intervals for detecting the changes in capacitance, as distances between the sensing circuit unit and the plurality of intersection points increase.

The sensing circuit unit may decrease the time intervals for detecting the changes in capacitance, as distances between the sensing circuit unit and the plurality of intersection points decrease.

The signal converting unit may set times, at which the digital signal is generated from the changes in capacitance, differently according to the positions of the plurality of intersection points.

The parameters may be determined according to distances between the controller integrated circuit and the plurality of intersection points.

The controller integrated circuit may set the parameters differently according to distances between the plurality of intersection points and at least one of a power circuit unit, a wireless communications circuit unit, an antenna unit, and a display device driving circuit unit.

According to another aspect of the present invention, there is provided a touch sensing method including: detecting changes in capacitance from a plurality of intersection points at which a plurality of electrodes intersect each other; converting the changes in capacitance into a digital signal; and determining a touch from the digital signal, wherein the detecting of the changes in capacitance includes setting parameters for detecting the changes in capacitance differently according to positions of the plurality of intersection points.

The detecting of the changes in capacitance may include generating an analog signal by integrating the changes in capacitance generated in the plurality of intersection points.

The detecting of the changes in capacitance may include setting time intervals for integrating the changes in capacitance differently according to the positions of the plurality of intersection points.

The detecting of the changes in capacitance may include setting time intervals for integrating the changes in capacitance differently according to electric noise signals inputted into the plurality of intersection points.

The converting of the changes in capacitance into the digital signal may include setting time intervals for converting the changes in capacitance into the digital signal differently according to the positions of the plurality of intersection points.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an exterior of an electronic apparatus having a touch sensing apparatus according to an embodiment of the present invention;

FIG. 2 is a plan view illustrating a touch sensing panel electrically connected to a touch sensing apparatus according to an embodiment of the present invention;

FIG. 3 is a cross-sectional view of the touch sensing panel shown in FIG. 2;

FIG. 4 is a block diagram illustrating a touch sensing apparatus according to an embodiment of the present invention;

FIG. 5 is a block diagram illustrating the operation of a touch sensing apparatus according to an embodiment of the present invention; and

FIG. 6 is a flowchart illustrating a touch sensing method according to an embodiment of the present invention.

### DETAILED DESCRIPTION OF THE EMBODIMENTS

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and scope of the present invention. In addition, it should be understood that positions and arrangements of individual components in each embodiment may be changed without departing from the spirit and scope of the present invention. Therefore, a detailed description provided below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

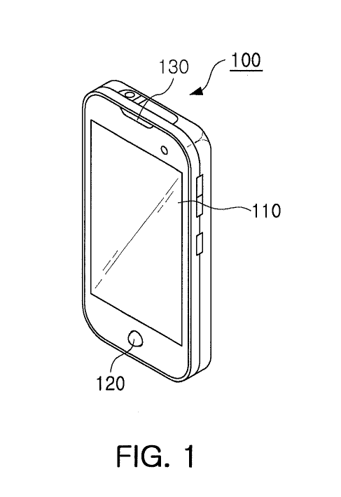

FIG. 1 is a view showing an electronic apparatus to which a touch sensing apparatus according to an embodiment of the present invention is applicable. Referring to FIG. 1, an electronic apparatus 100 according to the present embodiment includes a display apparatus 110 for outputting an image, an input unit 120, an audio unit 130 for outputting audio, and a touch sensing apparatus integrated with the display apparatus 110.

As shown in FIG. 1, in the case of a mobile apparatus, the touch sensing apparatus is generally provided integrally with the display apparatus and needs to have high light transmittance enough to transmit the image displayed by the display apparatus. Therefore, the touch sensing apparatus may be implemented by forming a sensing electrode using a transparent and electrically conductive material such as indium-tin oxide (ITO), indium zinc oxide (IZO), zinc oxide (ZnO), carbon nano tube (CNT), or graphene, on a base substrate formed of a transparent film material such as polyethylene terephthalate (PET), polycarbonate (PC), polyethersulfone (PES), polyimide (PI), or the like. The display apparatus may include a wiring pattern disposed in a bezel area thereof, and the wiring pattern is connected to the sensing electrode formed of the transparent conductive material. Since the wiring pattern is visually shielded by the bezel area, the wiring pattern may be formed of a metallic material such as silver (Ag), copper (Cu), or the like.

In the case in which the touch sensing apparatus according to the embodiment of the present invention may not be provided integrally with the display apparatus like in a touch pad of a notebook computer, the touch sensing apparatus may be manufactured by simply patterning the sensing electrode on a circuit substrate with metal. However, for convenience of explanation, the touch sensing apparatus and method according to the embodiment of the present invention will be described based on the touch screen.

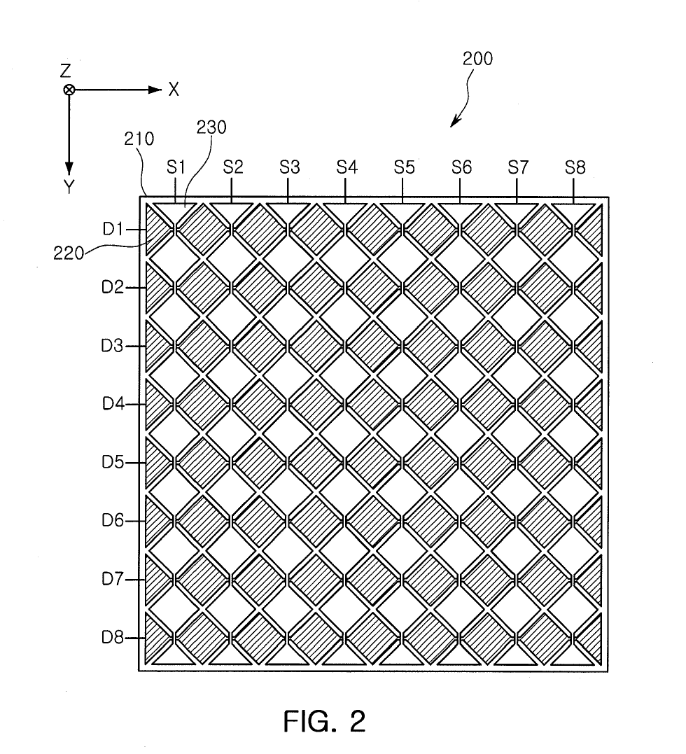

FIG. 2 is a plan view showing a touch sensing panel electrically connected to a touch sensing apparatus according to an embodiment of the present invention.

Referring to FIG. 2, a touch sensing panel 200 according to this embodiment includes a substrate 210 and a plurality of sensing electrodes 220 and 230 provided on the substrate 210. Although not shown in FIG. 2, each of the plurality of sensing electrodes 220 and 230 may be electrically connected to the wiring pattern of the circuit board attached to one end of the substrate 210 through a wire and a bonding pad. A controller integrated circuit is mounted on the circuit board to detect sensed signals generated from the plurality of sensing electrodes 220 and 230 and determine the touch based thereon.

In the touch screen apparatus, the substrate 210 may be a transparent substrate in which the sensing electrodes 220 and 230 maybe formed, and may be formed of a plastic material such as polyimide (PI), polymethylmethacrylate (PMMA), polyethyleneterephthalate (PET), or polycarbonate (PC) or tempered glass. Further, apart from an area in which the sensing electrodes 220 and 230 are formed, a predetermined printing area for the wire connected to the sensing electrodes 220 and 230 may be formed on the substrate 210 in order to visually shield the wire formed of an opaque metallic material.

The plurality of sensing electrodes 220 and 230 may be provided on one surface or both surfaces of the substrate 210. In the case of the touch screen apparatus, the plurality of sensing electrodes 220 and 230 may be formed of a transparent conductive material such as indium-tin oxide (ITO), indium zinc-oxide (IZO), zinc oxide (ZnO), carbon nano tube (CNT), or grapheme based material. Although the sensing electrodes 220 and 230 having a rhombus or diamond-shaped pattern are shown in FIG. 2, the sensing electrodes 220 and 230 may have various patterns using polygonal shapes such as a rectangle, a triangle, and the like.

The plurality of sensing electrodes 220 and 230 include first electrodes 220 extending in an X-axis direction and second electrodes 230 extending in a Y-axis direction. The first electrodes 220 and the second electrodes 230 may be provided on both surfaces of the substrate 210 or provided on different substrates to intersect each other. In the case in which both the first and second electrodes 220 and 230 are provided on one surface of the substrate 210, a predetermined insulating layer may be partially formed at an intersection point between the first and second electrodes 220 and 230.

A touch sensing apparatus that is electrically connected to the plurality of sensing electrodes 220 and 230 to sense a touch detects capacitance changes sensed in the plurality of sensing electrodes 220 and 230 and senses the touch therefrom. The first electrodes 220 are connected to channels defined as D1 to D8 in the controller integrated circuit to receive a predetermined driving signal, and the second electrodes 230 are connected to channels defined as S1 to S8 to be used in order for the controller integrated circuit to detect a sensed signal. In this case, the controller integrated circuit may detect mutual-capacitance changes generated between the first and second electrodes 220 and 230 as the sensed signal, and may sequentially apply the driving signal to the individual first electrodes 220 and simultaneously detect capacitance changes in the second electrodes 230.

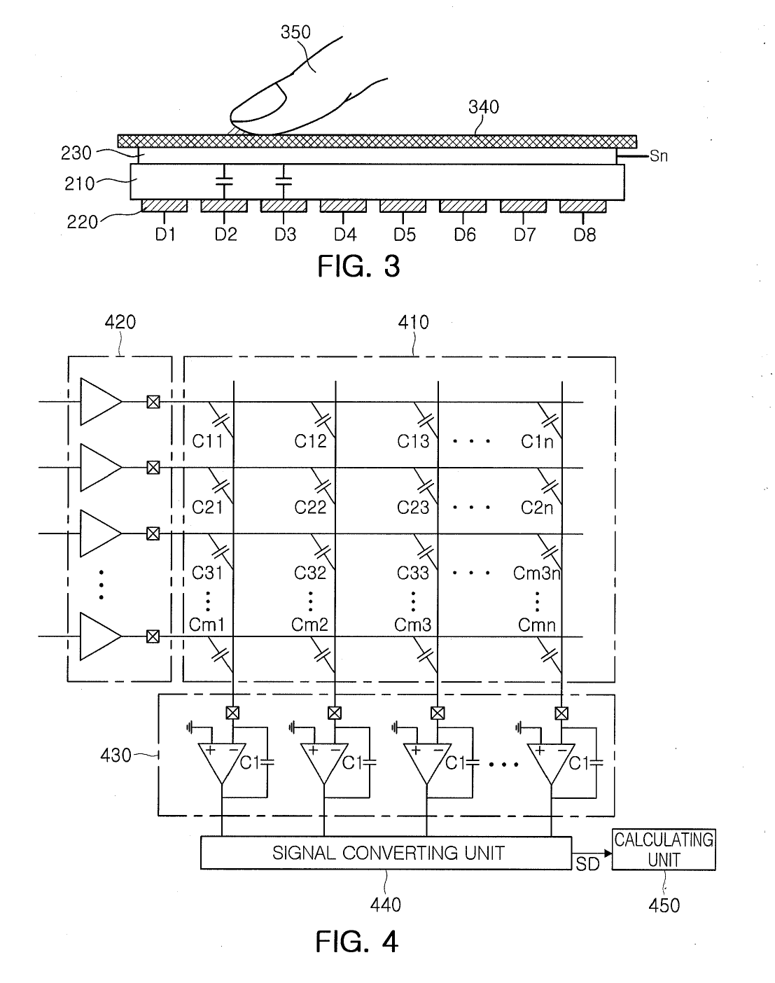

FIG. 3 is a cross-sectional view of the touch sensing panel shown in FIG. 2.

FIG. 3 is a cross-sectional view of the touch sensing panel 200 shown in FIG. 2 taken in a Y-Z direction. The touch sensing panel 200 may further include a cover lens 340 receiving the touch, in addition to the substrate 210 and the plurality of sensing electrodes 220 and 230 described in FIG. 2. The cover lens 340 is provided on the second electrodes 330 used to detect the sensed signal such that it may receive the touch from a touching object 350 such as a finger.

When the driving signal is sequentially applied to the first electrodes 220 through the channels D1 to D8, mutual-capacitance is generated between the first and second electrodes 220 and 230. When the driving signal is sequentially applied to the first electrodes 220, changes in capacitance may occur between the first and second electrodes 220 and 230 adjacent to an area contacted by the touching object 350. The changes in capacitance may be proportionate to a dimension of an area overlapped among the touching object 350, the first electrodes 220 applied with the driving signal and the second electrodes 230. In FIG. 3, the mutual-capacitance generated between the first and second electrodes 220 and 230 connected to the channels D2 and D3 is influenced by the touching object 350.

FIG. 4 is a block diagram of a touch sensing apparatus according to an embodiment of the present invention.

Referring to FIG. 4, a touch sensing apparatus according to this embodiment includes a panel unit 410, a driving circuit unit 420, a sensing circuit unit 430, a signal converting unit 440, and a calculating unit 450. The panel unit 410 includes a plurality of first electrodes extending in a first axis direction (a horizontal direction of FIG. 4) and a plurality of second electrodes extending in a second axis direction intersecting the first axis direction (a vertical direction of FIG. 4). Changes in capacitance C11 to Cmn are generated at intersection points between the first and second electrodes. The changes in capacitance C11 to Cmn generated at the intersection points of the first and second electrodes may be changes in mutual-capacitance generated by a driving signal applied to the first electrodes by the driving circuit unit 420 . Meanwhile, the driving circuit unit 420, the sensing circuit unit 430, the signal converting unit 440, and the calculating unit 450 may be configured as an integrated circuit (IC).

The driving circuit unit 420 applies a predetermined driving signal to the first electrodes of the panel unit 410. The driving signal may have a square wave, a sine wave, a triangle wave, and the like having a predetermined cycle and a predetermined amplitude. The driving signal may be sequentially applied to the plurality of first electrodes, respectively. As shown in FIG. 4, the circuits for generating the driving signals and applying the driving signals to the first electrodes are individually connected to the plurality of respective first electrodes. However, a single driving signal generating circuit maybe used together with a switching circuit such that it may apply the driving signal to the plurality of first electrodes through the switching circuit.

The sensing circuit unit 430 may include integral circuits for sensing the changes in capacitance C11 to Cmn in the second electrodes. The integral circuit may include at least one operational amplifier and a capacitor C1 having a predetermined capacitance. An inversion input terminal of the operational amplifier is connected to the second electrode to convert the changes in capacitance C11 to Cmn to an analog signal such as a voltage signal and output the signal. When the driving signal is sequentially applied to the plurality of first electrodes, respectively, the changes in capacitance may be simultaneously detected in the plurality of second electrodes, and thus, the number of integral circuits may correspond to the number (m) of the second electrodes.

The signal converting unit 440 generates a digital signal S_{D} from the analog signal generated by the integral circuit. For example, the signal converting unit 440 may include a time-to-digital converter (TDC) circuit measuring a time required for a voltage type analog signal outputted from the sensing circuit unit 430 to reach a predetermined reference voltage level and converting the measured time into a digital signal S_{D}, or an analog-to-digital converter (ADC) circuit measuring a change in a level of an analog signal outputted from the sensing circuit unit 430 for a predetermined time and converting the measured change into a digital signal S_{D}. The calculating unit 450 determines the touch applied to the panel unit 410 by using the digital signal S_{D}. For example, the calculating unit 450 may determine the number of touches applied to the panel unit 410, coordinates of the touch, movements during the touch, and the like.

As shown in FIG. 4, the plurality of first electrodes and the plurality of second electrodes extend in different directions to form a plurality of intersection points, and the changes in capacitance C11 to Cmn are generated in the respective intersection points. The changes in capacitance are generated in the intersection points of the first and second electrodes to which the driving signal is applied as described above. An error may be included in the changes in capacitance by a first resistance component determined according to a distance between the intersection point at which the change in capacitance is detected and the driving circuit unit 420 outputting the driving signal and a second resistance component determined according to a distance between the intersection point at which the change in capacitance is detected and the integral circuit of the sensing circuit unit 430.

For example, on the assumption that the driving signal is applied to the first electrode positioned in an uppermost portion in FIG. 4, the distances between the sensing circuit unit 430 and the intersection points at which the changes in capacitance C11 to C1n are detected may be equal to each other. However, since the change in capacitance C1n is generated by the driving signal transferred to the intersection point distant from the driving circuit unit 420, the change in capacitance C1n is largely affected by the resistance component as compared with other changes in capacitance. This means that an RC time constant which is a parameter as a criterion to generate the analog voltage signal by integrating the change in capacitance by using the integral circuit of the sensing circuit unit 430 is large.

Further, an error may be included in the changes in capacitance C11 to Cmn detected by the sensing circuit unit 430 due to electric noise transferred from electronic components adjacent to the panel unit 410, such as an RF module, an antenna, an audio device, a display device, a power supply circuit, and the like, other than the resistance components present in the plurality of first electrodes and the plurality of second electrodes. For example, in the case that the antenna and the RF module are provided to be adjacent to the left side of the panel unit 410, a large amount of errors may be included in the changes in capacitance C11 to Cm1.

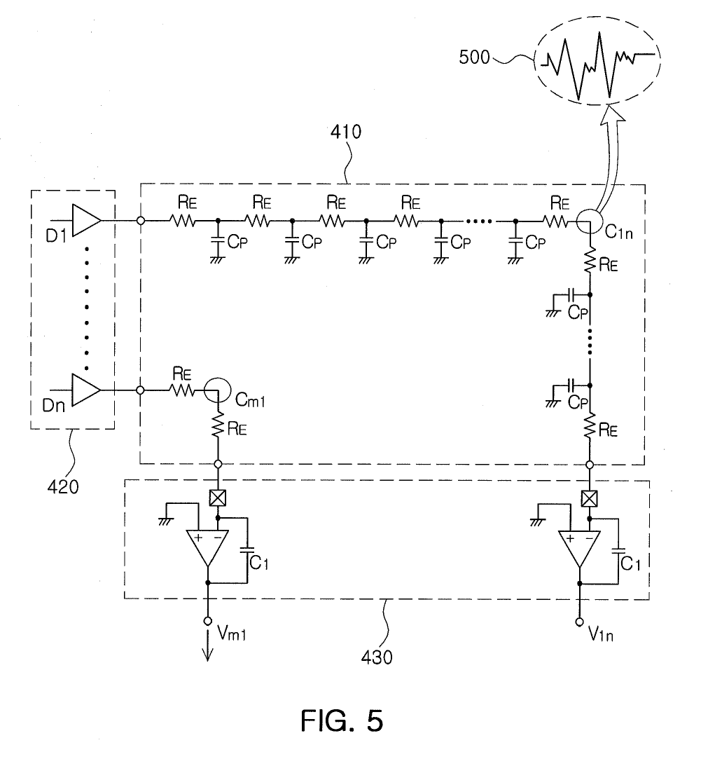

Therefore, in the embodiment of the present invention, in order to minimize the influence caused by of the resistance components present in the plurality of electrodes and the influence caused by the electric noise from other electronic components adjacent to the touch sensing apparatus, the parameters required for the sensing circuit unit 430 to detect the changes in capacitance C11 to Cmn are set differently at the individual intersection points at which the changes in capacitance C11 to Cmn are detected. For example, at the time of generating the analog voltage signal by integrating the changes in capacitance C11 to Cmn, in order to reflect the influences caused by the resistance components of the respective electrodes and the electric noise transferred from other electronic components, integral time intervals may be set differently at the respective intersection points at which the changes in capacitance C11 to Cmn are detected. Hereinafter, the operation of the touch sensing apparatus according to the embodiment of the present invention will be described with reference to FIG. 5.

FIG. 5 is a block diagram illustrating an operation of a touch sensing apparatus according to an embodiment of the present invention.

Referring to FIG. 5, integral time intervals are set differently according to the resistance components present in the electrodes connected to the respective integral circuits that generate the analog voltage signals by integrating the changes in capacitance and the magnitude of the electric noise inputted into the corresponding electrodes. That is, in the case of an integral circuit connected to an electrode having a relatively small amount of resistance components or a low possibility of electric noise, an integral time interval is set to be relatively short. On the contrary, in the case of an integral circuit connected to an electrode having a relatively large amount of resistance components or a high possibility of electric noise, an integral time interval is set to be relatively long.

In consideration of the resistance component which is one of parameters required to determine the integral time intervals, the integral time interval of each integral circuit included in the sensing circuit unit 430 may be determined according to a distance between the intersection point at which the change in capacitance is detected and the integral circuit and a distance between the intersection point at which the change in capacitance is detected and the driving circuit unit 420. Referring to FIG. 4, the integral time interval to detect the change in capacitance C1n may be set to be longer than the integral time interval to detect the change in capacitance Cm1. Further, on the assumption that a horizontal length and a vertical length of the panel unit 410 are equal to each other, the integral time interval to detect the change in capacitance C11 may be set to be equal to the integral time interval to detect the change in capacitance Cmn.

Further, the integral time intervals may be set differently for each integral circuit in consideration of electric noise generated from other electronic components adjacent to the touch sensing apparatus. For example, on the assumption that specific first and second electrodes are adjacent to a power supply circuit, an RF circuit, an antenna, and the like, the integral time interval of the integral circuit detecting the change in capacitance generated at the intersection point defined by the corresponding first and second electrodes may be set to be relatively long.

Meanwhile, as the integral time interval is set differently for each integral circuit included in the sensing circuit unit 430 as described above, the time at which the analog voltage signal outputted by the integral circuit included in the sensing circuit unit 430 is converted into the digital signal S_{D} should also be set differently for each integral circuit. Referring to FIG. 5, in the case that the digital signal S_{D} is generated from the analog voltage signal outputted by the integral circuit having a relatively long integral time interval, the time at which the digital signal S_{D} is generated in consideration of the integral time interval longer than other integral circuits is also shifted back. That is, in FIG. 4, in the case that the time of generating the digital signal from the analog voltage signal corresponding to the change in capacitance Cm1 is represented by tₘ₁ and the time of generating the digital signal from the analog voltage signal corresponding to the change in capacitance Cmn is represented by tₘₙ, both times are expressed by the following relationship: tₘ₁<tₘₙ.

Meanwhile, the integral time interval may be set differently for each integral circuit by reflecting an influence caused by parasitic capacitance present in each electrode other than the influence caused by the resistance component of each electrode and the influence caused by the electric noise due to the electronic component adjacent to the touch sensing apparatus. The parasitic capacitance may be proportionate to a distance from the intersection point at which the capacitance change is generated to the driving circuit unit or the sensing circuit unit 430. Accordingly, the integral time interval is set to be long in proportion to the distance from the intersection point to the driving circuit unit 420 and the sensing circuit unit 430, to thereby reflect the influence caused by the parasitic component of each electrode, similar to the resistance component.

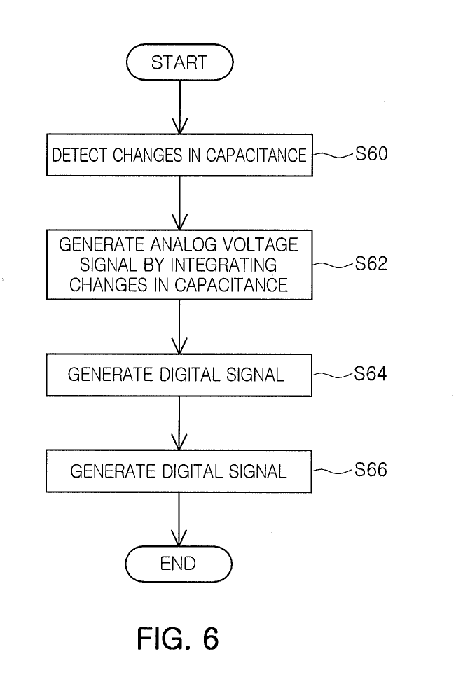

FIG. 6 is a flowchart illustrating a touch sensing method according to an embodiment of the present invention.

Referring to FIG. 6, the touch sensing method according to this embodiment of the present invention initiates with detecting changes in capacitance generated at intersection points between a plurality of first electrodes and a plurality of second electrodes (S60). The changes in capacitance detected in operation S60 may be changes in mutual-capacitance generated at the intersection points between the first electrodes to which a driving signal is applied and the second electrodes intersecting the first electrodes to which the driving signal is applied.

As described above, an error may be included in the change in capacitance detected in the sensing circuit unit 430, due to a resistance component R_{g} or a parasitic capacitive component C_{P} present in the first electrode or the second electrode defining each intersection point and an electric noise signal 500 generated from other electronic components adjacent to the touch sensing apparatus. Accordingly, the integral time intervals may be set differently for each integral circuit included in the sensing circuit unit 430 in order to compensate for the influences caused by the resistance component R_{g} and the parasitic capacitance component C_{P} that are present in the electrode and by the electric noise signal 500.

In the case that the change in capacitance is detected, an analog voltage signal is generated by integrating the detected change in capacitance (S62). As shown in FIGS. 4 and 5, the sensing circuit unit 430 may include a plurality of integral circuits connected to the plurality of second electrodes, respectively. The respective integral circuits may have different integral time intervals in order to compensate for the influence caused by the resistance component R_{g} or the parasitic capacitance component C_{P} set differently for each intersection point at which the change in capacitance is detected and the electric noise signal 500. The signal converting unit 440 converts the analog voltage signal generated from the integral circuit by integrating the change in capacitance into a digital signal S_{D} (564).

The signal converting unit 440 may include a TDC circuit unit measuring a time required for the analog voltage signal increasing or decreasing according to the time to reach a predetermined reference level and converting the measured time into the digital signal S_{D}. In the present embodiment, since the respective integral circuits may have different integral time intervals, the time at which the signal converting unit 440 generates the digital signal S_{D} may also be set differently according to the integral time interval of the integral circuit generating the analog voltage signal inputted into the signal converting unit 440. The calculating unit 450 determines a touch by using the digital signal S_{D} generated by the signal converting unit (S66).

As set forth above, according to embodiments of the present invention, parameters required to detect changes in capacitance are set differently according to positions at which the changes in capacitance are detected on a 2D plane of a panel unit in generating an analog signal from the changes in capacitance. Accordingly, a touch can be accurately determined in consideration of an influence of electric noise generated from other electronic components adjacent to a touch sensing apparatus, e.g., an RF module, a display device, an audio/video driving circuit, and an antenna unit, and a difference in electric signal transmission characteristics according to positions at which the changes in capacitance are detected.

While the present invention has been shown and described in connection with the embodiments, it will be apparent to those skilled in the art that modifications and variations can be made without departing from the spirit and scope of the invention as defined by the appended claims.

What is claimed is:

1. A touch sensing apparatus, comprising:
a plurality of first electrodes extending along a first axis;
a plurality of second electrodes extending along a second axis intersecting the first axis and forming a plurality of intersection points by intersecting the plurality of first electrodes; and
a controller integrated circuit determining a touch by detecting changes in capacitance generated in the plurality of intersection points,
wherein the controller integrated circuit sets parameters for detecting the changes in capacitance differently according to positions of the plurality of intersection points.

2. The touch sensing apparatus of claim 1, wherein the controller integrated circuit includes:
a sensing circuit unit including an integral circuit detecting the changes in capacitance;
a signal converting unit generating a digital signal from the changes in capacitance detected by the sensing circuit unit; and
a calculating unit determining the touch from the digital signal.

3. The touch sensing apparatus of claim 2, wherein the sensing circuit unit sets time intervals differently for the integral circuit to detect the changes in capacitance according to the positions of the plurality of intersection points.

4. The touch sensing apparatus of claim 3, wherein the sensing circuit unit increases the time intervals for detecting the changes in capacitance, as distances between the sensing circuit unit and the plurality of intersection points increase.

5. The touch sensing apparatus of claim 3, wherein the sensing circuit unit decreases the time intervals for detecting the changes in capacitance, as distances between the sensing circuit unit and the plurality of intersection points decrease.

6. The touch sensing apparatus of claim 2, wherein the signal converting unit sets times, at which the digital signal is generated from the changes in capacitance, differently according to the positions of the plurality of intersection points.

7. The touch sensing apparatus of claim 1, wherein the parameters are determined according to distances between the controller integrated circuit and the plurality of intersection points.

8. The touch sensing apparatus of claim 1, wherein the controller integrated circuit sets the parameters differently according to distances between the plurality of intersection points and at least one of a power circuit unit, a wireless communications circuit unit, an antenna unit, and a display device driving circuit unit.

9. A touch sensing method, comprising:
detecting changes in capacitance from a plurality of intersection points at which a plurality of electrodes intersect each other;
converting the changes in capacitance into a digital signal; and
determining a touch from the digital signal,
wherein the detecting of the changes in capacitance includes setting parameters for detecting the changes in capacitance differently according to positions of the plurality of intersection points.

10. The touch sensing method of claim 9, wherein the detecting of the changes in capacitance includes generating an analog signal by integrating the changes in capacitance generated in the plurality of intersection points.

11. The touch sensing method of claim 10, wherein the detecting of the changes in capacitance includes setting time intervals for integrating the changes in capacitance differently according to the positions of the plurality of intersection points.

12. The touch sensing method of claim 10, wherein the detecting of the changes in capacitance includes setting time intervals for integrating the changes in capacitance differently according to electric noise signals inputted into the plurality of intersection points.

13. The touch sensing method of claim 9, wherein the converting of the changes in capacitance into the digital signal includes setting time intervala for coverting the changes in capacitance into the digital signal differently according to the positions of the plurality of intersection points.
